(19) United States
(12) Patent Application Publication
(10) Pub. No.: US 2018/0105207 A1
(43) Pub. Date: Apr. 19, 2018

(54) STEERING ASSEMBLY FOR A WORK MACHINE

(71) Applicant: Ariens Company, Brillion, WI (US)

(72) Inventors: William D. Maile, De Pere, WI (US); Paul Ferrier, Brillion, WI (US); Michael Rukamp, Brillion, WI (US); Mathew Weglarz, Brillion, WI (US); Brent P. Berglund, Brillion, WI (US)

(21) Appl. No.: 15/787,927

(22) Filed: Oct. 19, 2017

Related U.S. Application Data
(60) Provisional application No. 62/410,241, filed on Oct. 19, 2016.

(51) Int. Cl. B62D 11/10; B62D 11/00; B60K 7/00

(52) U.S. Cl. CPC B62D 11/10; B62D 11/005; B60Y 2200/225; B60K 7/0015; B62D 11/006

(57) ABSTRACT

A work machine includes a machine frame, a prime mover supported by the machine frame, and wheels rotatably coupled to the machine frame and driven by the prime mover. The wheels are supported on a ground surface. The work machine further includes a steering assembly having a pivot frame pivotally coupled to the machine frame about a pivot axis. The steering assembly is pivotable about the pivot axis relative to the machine frame to turn the work machine. The steering assembly also includes a damping mechanism positioned between the pivot frame and the machine frame to inhibit oscillations.

### CROSS-REFERENCE TO RELATED APPLICATIONS

This application claims benefit to U.S. Provisional Patent Application No. 62/410,241, filed Oct. 19, 2016, the entire contents of which are incorporated by reference herein.

### FIELD OF THE INVENTION

The present invention relates to self-propelled, walk-behind work machines (e.g., yard tractors, lawn mowers, snow throwers, etc.) and, more particularly, to steering assemblies for work machines.

### SUMMARY

In one embodiment, the invention provides a work machine including a machine frame, a prime mover supported by the machine frame, and wheels rotatably coupled to the machine frame and driven by the prime mover. The wheels are supported on a ground surface. The work machine further includes a steering assembly having a pivot frame pivotally coupled to the machine frame about a pivot axis. The steering assembly is pivotable about the pivot axis relative to the machine frame to turn the work machine. The steering assembly also includes a damping mechanism positioned between the pivot frame and the machine frame to inhibit oscillations.

In other embodiments, the invention provides a work machine including a machine frame, a prime mover supported by the machine frame, and wheels rotatably coupled to the machine frame and driven by the prime mover. The wheels are supported on a ground surface. The work machine further includes a steering assembly pivotally coupled to the machine frame rearward of the prime mover and a damping mechanism interconnecting the steering assembly and the machine frame to resist motion therebetween.

Other aspects of the invention will become apparent by consideration of the detailed description and accompanying drawings.

### BRIEF DESCRIPTION OF THE DRAWINGS

FIG. 1 is a perspective view of a work machine.

FIG. 2 is a side view of the work machine.

FIG. 3 is a rear perspective view of a portion of the work machine, the work machine including a steering assembly.

FIG. 4A is a rear perspective view of the steering assembly.

FIG. 4B is a front perspective view of the steering assembly.

FIG. 4C is a rear plan view of the steering assembly.

FIG. 5 is an enlarged perspective view of a portion of the work machine and the steering assembly including a first damping mechanism.

FIG. 6 is an enlarged rear view of a portion of the work machine and the steering assembly including a second damping mechanism.

FIG. 7 is an enlarged view of a portion of the steering mechanism with the second damping mechanism.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

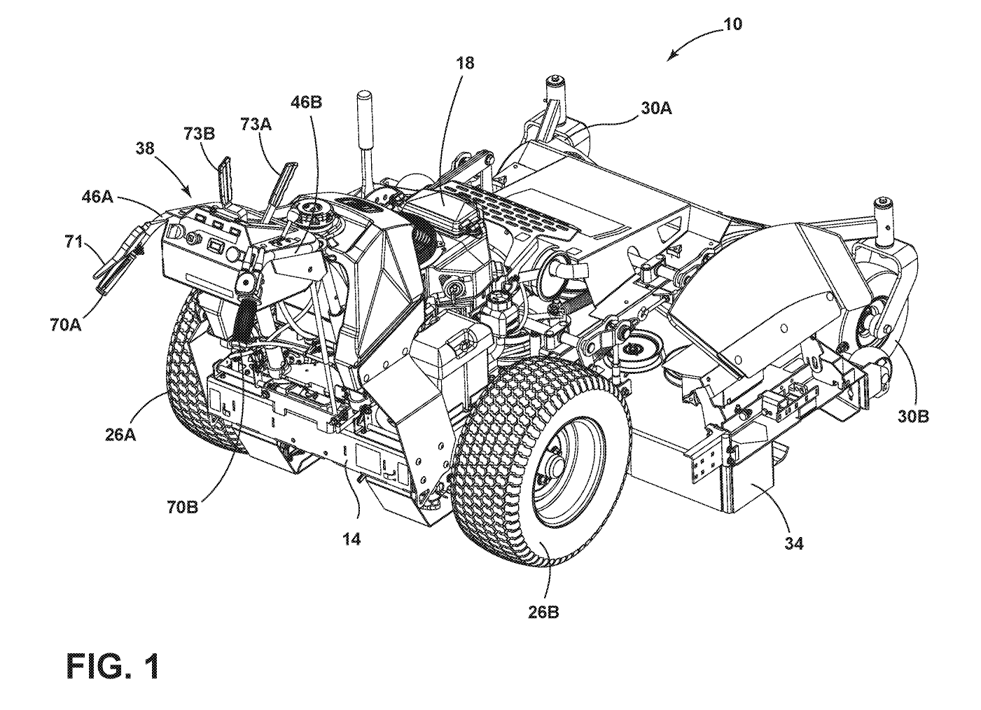

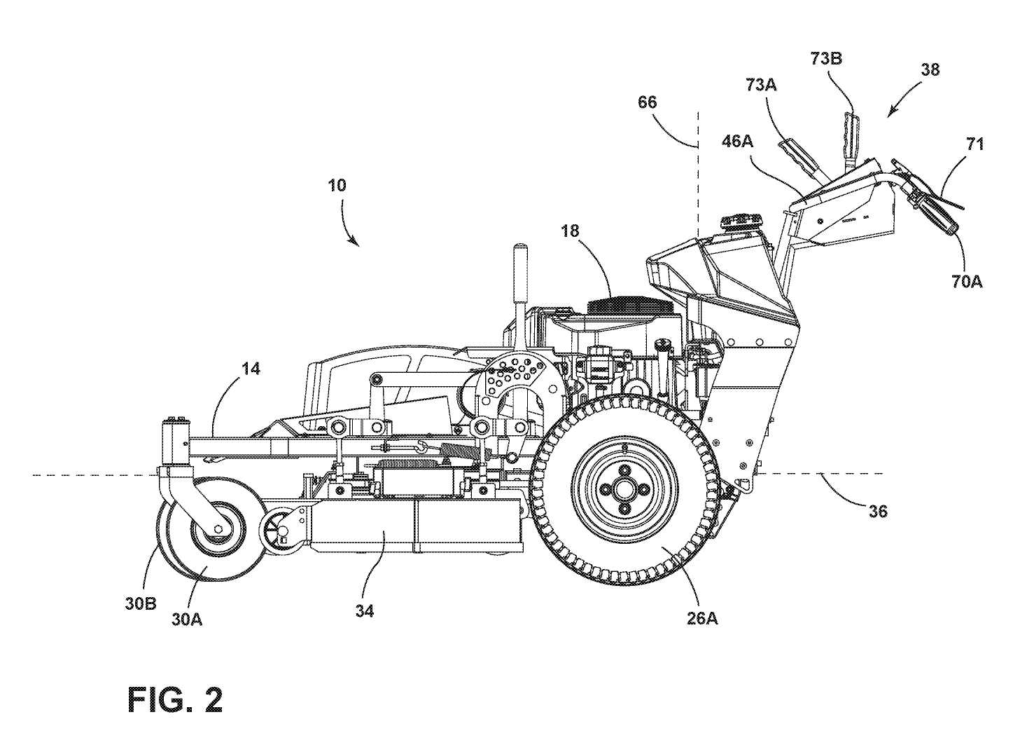

FIGS. 1 and 2 illustrate a work machine 10. In the illustrated embodiment, the work machine 10 is a self-propelled, walk behind lawn mower. In other embodiments, the work machine 10 may be another type of machine, such as a lawn or yard tractor, a snow thrower, or the like. In some embodiments, the work machine 10 may be a drive unit to which other work accessories (e.g., a lawn mower cutting deck, a snow thrower auger and housing, a tiller, etc.) are releasably attached.

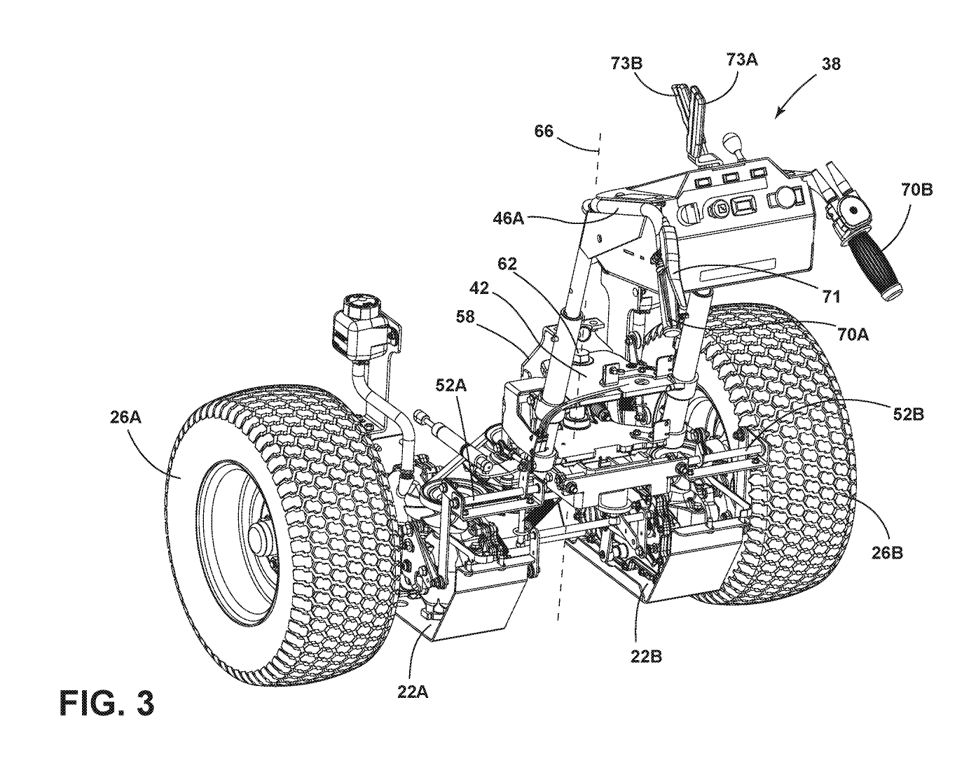

The illustrated work machine 10 includes a machine frame 14, a prime mover 18, hydrostatic transmissions 22A, 22B (FIG. 3), two driven wheels 26A, 26B, two passive wheels 30A, 30B, a cutting deck 34, and a steering assembly 38. The machine frame 14 defines a longitudinal axis 36 extending between a rear of the frame 14 and a front of the frame 14, and the longitudinal axis 36 is parallel with the direction of travel of the work machine 10. The prime mover 18 is supported by the machine frame 14 and drives the other components of the work machine 10. For example, the prime mover 18 may power the hydrostatic transmissions 22A, 22B to drive the driven wheels 26A, 26B, and/or may drive (e.g., rotate) cutting blades on the cutting deck 34. In the illustrated embodiment, the prime mover 18 includes an internal combustion engine. In other embodiments, the prime mover 18 may include other suitable drive elements, such as electric motors, batteries, fuel cells, and the like.

As shown in FIG. 3, the hydrostatic transmissions 22A, 22B are supported by the machine frame 14 adjacent the driven wheels 26A, 26B. Each hydrostatic transmission 22A, 22B includes a pump and a motor. The pumps are operatively coupled to the prime mover 18 (e.g., through belt drives, etc.). The motors are coupled to the pumps and to the driven wheels 26A, 26B to selectively rotate the wheels 26A, 26B in forward and reverse directions.

Referring back to FIGS. 1 and 2, the driven wheels 26A, 26B and the passive wheels 30A, 30B support the machine frame 14 on the ground. The driven wheels 26A, 26B are located toward a rear of the machine frame 14, and the passive wheels 30A, 30B are located toward a front of the machine frame 14. As noted above, the driven wheels 26A, 26B are driven (e.g., rotated) by the prime mover 18 through the hydrostatic transmissions 22A, 22B to propel the work machine 10 in forward and reverse directions. The driven wheels 26A, 26B are independently driven, in that the wheels 26A, 26B may be rotated at different speeds or in different directions. Rotating the wheels 26A, 26B at different speeds turns the work machine 10, while rotating the wheels 26A, 26B in different directions allows the work machine 10 to execute a tighter turn. In the illustrated embodiment, the passive wheels 30A, 30B are caster wheels, but in other embodiments, the passive wheels 30A, 30B may also be driven by the prime mover 18.

The cutting deck 34 is supported by the machine frame 14 between the driven wheels 26A, 26B and the passive wheels 30A, 30B. The cutting deck 34 can include one or more cutting blades underneath the deck 34. The cutting blades are rotated by the prime mover 18 (e.g., through a belt drive, etc.) to cut vegetation beneath the deck 34. In other embodiments, the cutting deck 34 may be omitted and replaced with another type of work implement, such as a snow thrower auger.

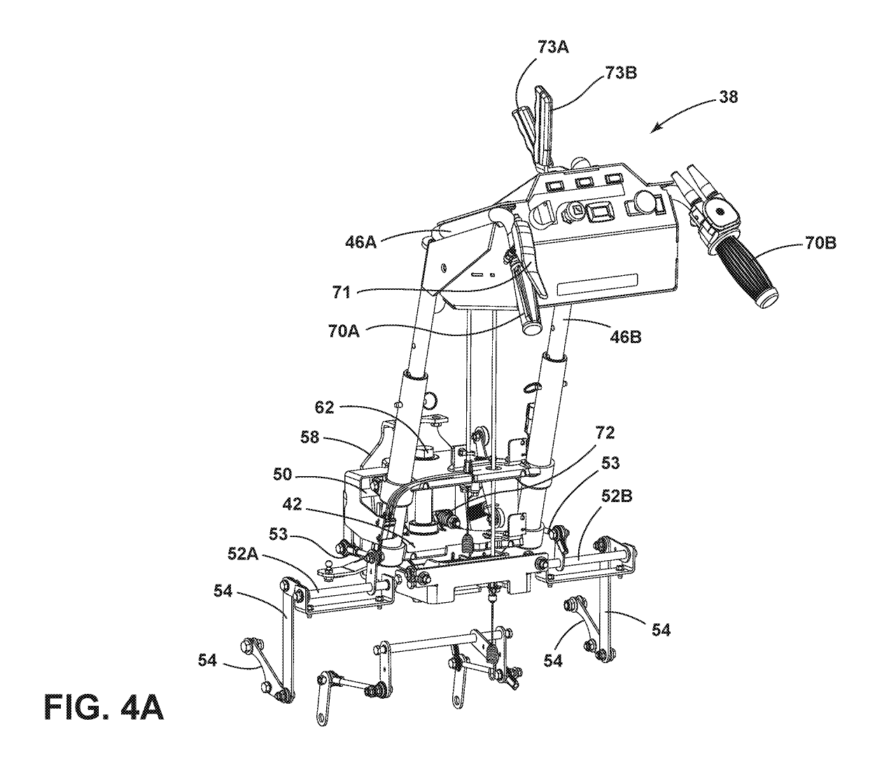

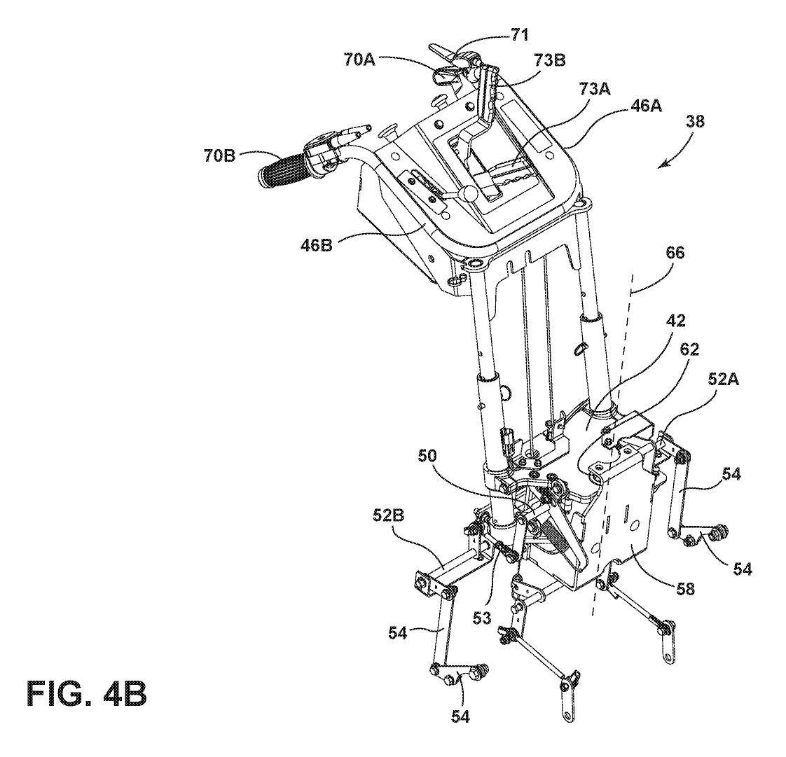

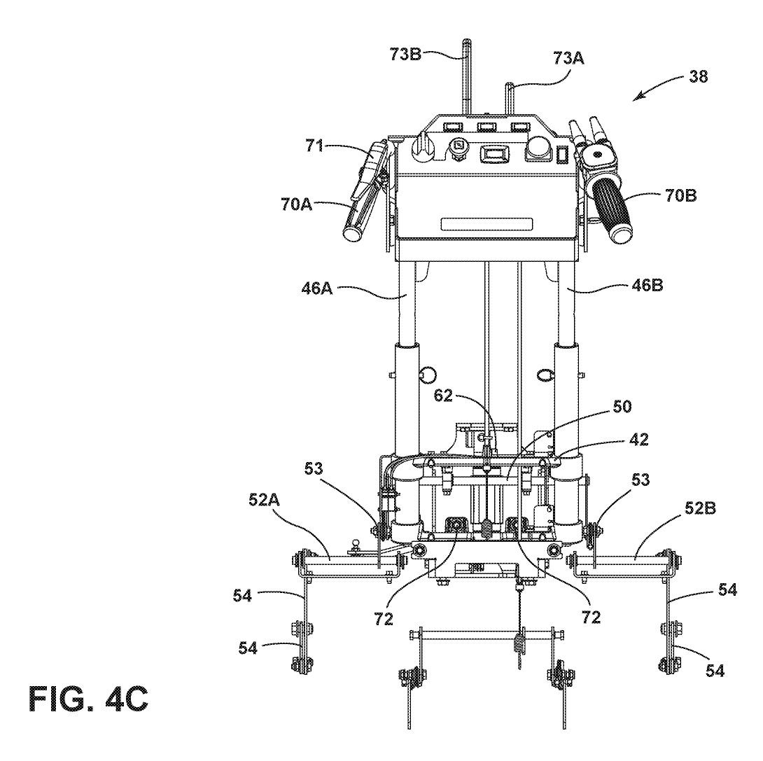

The steering assembly 38 is supported by the machine frame 14 and controls operation of the work machine 10. The steering assembly 38 is positioned rearward of the prime mover 18 and the cutting deck 34, and extends generally upward from the machine frame 14. As shown in FIGS. 3 to 4C, the illustrated steering assembly 38 includes a pivot frame 42, two handlebar tubes 46A, 46B extending from the pivot frame 42, an upper control shaft 50, two lower control shafts 52, a first set of links 53 connecting the upper control shaft 50 to the lower control shafts 52, and a second set of links 54 coupled between the pumps of the hydrostatic transmissions 22A, 22B and the lower control shafts 52. Some components of the steering assembly 38 (e.g., the pivot frame 42, the handlebar tubes 46A, 46B, the upper control shaft 50, the links 54, etc.) are similar to corresponding components disclosed in U.S. Patent Application Publication No. 2015/0107916, the entire contents of which are incorporated by reference herein.

The pivot frame 42 pivotally couples the steering assembly 38 to the machine frame 14. In the illustrated embodiment, the pivot frame 42 is pivotally coupled to a bracket 58 that is fixed to the machine frame 14. The illustrated pivot frame 42 is secured to the bracket 58 by fasteners 62 (e.g., bolts) that define a pivot axis 66 (FIG. 2) of the pivot frame 42 relative to the machine frame 14. In the illustrated embodiment, the pivot axis 66 is a substantially vertical or perpendicular axis relative to the longitudinal axis 36 of the chassis 14. Specifically, the pivot axis 66 is substantially perpendicular to the ground. In other embodiments, the pivot axis 66 may be tilted rearward toward a user operating the work machine 10. For example, the pivot axis 66 may be tilted about ±10 degrees from perpendicular (i.e., vertical) relative to the longitudinal axis 36

The handlebar tubes 46A, 46B are fixed to the pivot frame 42 and extend upwardly. The handlebar tubes 46A, 46B support grips 70A, 70B and operator controls that are engageable by a user to operate the work machine. In the illustrated embodiment, one of the grips 70B is a rotatable twist grip that controls the general speed and direction of the driven wheels 26A, 26B. When the twist grip 70B is rotated in one direction, the wheels 26A, 26B are driven to rotate in a first direction (e.g., forward). When the twist grip 70B is rotated in an opposite direction, the wheels 26A, 26B are driven to rotate in a second direction (e.g., reverse). The speed of rotation in either direction is also determined by the degree of rotation of the twist grip 70B (i.e., rotating the twist grip 70B further from its “neutral” position drives the driven wheels 26A, 26B faster). An operator presence switch 71 (e.g., a pivoting lever) is located adjacent the first grip 70A. The operator presence switch 71 is actuated to allow a user to turn the work machine 10 on and/or to allow the user to drive the work machine 10 in forward or reverse. In other embodiments, other suitable operator controls may also or alternatively be included for controlling the speed and direction of the driven wheels 26A, 26B. For example, the work machine 10 may include a speed selector lever rather than a twist grip to control each driven wheel 26A, 26B.

The upper control shaft 50 is supported by the pivot frame 42 and operatively coupled to the rotatable twist grip 70B through cables and linkages. The first links 53 are connected to ends of the upper control shaft 50 and to ends of the lower control shafts 52A, 52B. The first links 53 transmit motion of the upper control shaft 50 to the lower control shafts 52A, 52B. The lower control shafts 52A, 52B are positioned beneath the pivot frame 42 and are supported by the machine frame 14 adjacent a corresponding driven wheel 26A, 26B. The second links 54 are connected to ends of the lower control shafts 52A, 52B opposite from the first links 53. The second links 54 are also operatively coupled to swash plates within the pumps of the hydrostatic transmissions 22A, 22B. The second links 54 transmit motion of the lower control shafts 52 to the swash plates.

Rotating the twist grip 70B actuates (e.g., rotates) the upper control shaft 50 to change operation of the hydrostatic transmissions 22A, 22B. More particularly, rotating the twist grip 70B rotates the upper control shaft 50 about its longitudinal axis, which actuates the first links 53. When the first links 53 are actuated, the first links 53 rotate the lower control shafts 52 about their longitudinal axes. Rotating the lower control shafts 52 actuates the second links 54. When the second links 54 are actuated, the second links 54 move the swash plates in the hydrostatic transmissions 22A, 22B to speed up, slow down, or change rotational direction of the hydrostatic transmission motors.

As the work machine 10 moves along the ground, the work machine 10 can be turned by pivoting the steering assembly 38 relative to the machine frame 14. The steering assembly 38 pivots about the pivot axis 66 (FIG. 2) when a user manipulates the handlebar tubes 46A, 46B to the left or to the right. Pivoting the steering assembly 38 changes the position of the upper control shaft 50 relative to the machine frame 14 (e.g., rotates the upper control shaft 50 about the pivot axis 66 rather than its longitudinal axis), which actuates the first links 53 and causes the lower control shafts 52 to rotate about their longitudinal axes. During this type of motion of the upper control shaft 50, the lower control shafts 52 rotate in opposite directions such that one driven wheel speeds up and the other driven wheel slows down. For example, when the steering assembly 38 is pivoted to the left, the left driven wheel 26A is sped up and the right driven wheel 26B is slowed down to turn the work machine 10 to the right. When the steering assembly 38 is pivoted to the right, the right driven wheel 26B is sped up and the left driven wheel 26A is slowed down to turn the work machine 10 to the left.

As shown in FIG. 4C, the steering assembly 38 also includes spring elements 72 coupled to the pivot frame 42. The spring elements 72 are laterally offset from the pivot axis 66 to bias the steering assembly 38 to a neutral (i.e., non-turning) position. In the illustrated embodiment, the steering assembly 38 includes two spring elements 72 on each side of the pivot axis 66. In other embodiments, the steering assembly 38 may include fewer or more spring elements 72 on each side of the pivot axis 66. In some embodiments, the spring elements 72 are compression springs, but other spring elements or detent-type design may also or alternatively be used.

Referring back to FIGS. 3-4C, the steering assembly 38 further includes a parking brake and a steering lock. The parking brake is controlled by a first control lever 73A, and the steering lock is controlled by a second control lever 73B. In other embodiments, other suitable types of actuators may alternatively be employed. Moving the first control lever 73A actuates the parking brake to, for example, engage or disengage brakes from the driven wheels 26A, 26B. Moving the second control lever 73B actuates the steering lock to, for example, engage or release a mechanical latch from the steering assembly 38. When the mechanical latch is engaged, the steering assembly 38 is inhibited from pivoting relative to the machine frame 14. This feature allows a user to drive the work machine 10 in long, straight lines without unintentionally turning (e.g., left turning, right turning, zero-speed turning, etc.). In some embodiments, the steering assembly 38 may still be pivotable a small amount when the steering lock is engaged to allow for small course corrections. When the mechanical latch is disengaged, the steering assembly 38 may be pivoted relative to the machine frame 14. In other embodiments, the steering lock may include other types of mechanical or electromechanical mechanisms to hold the steering assembly 38 in the neutral position. Generally, when the parking brake is activated so is the steering lock to avoid inadvertent damage to the hydrostatic transmissions 22A, 22B caused by a user rotating the steering assembly 38 when the parking brake is activated.

In the illustrated embodiment, the first and second control levers 73A, 73B are tied together such that moving the first control lever 73A to an engaged position (i.e., engaging the parking brake) also moves the second control lever 73B to an engaged position (i.e., engaging the steering lock). However, the first control lever 73A is movable independently of the second control lever 73B to a disengaged position (i.e., the parking brake can be disengaged without disengaging the steering lock). Conversely, moving the second control lever 73B to a disengaged position (i.e., disengaging the steering lock) also moves the first control lever 73A to the disengaged position (i.e., disengaging the parking brake), but the second control lever 73B is movable independently of the first control lever 73A to the engaged position (i.e., the steering lock can be engaged without engaging the parking brake).

In some scenarios, pivoting the steering assembly 38 relative to the machine frame 14 may cause uncontrolled oscillations of the work machine 10. For example, when the steering assembly 38 pivots, the work machine 10 may turn so fast that the machine 10 turns back the other way because movement of the steering assembly 38 lags behind the machine frame 14. This back-and-forth turning of the machine frame 14 relative to the steering assembly 38 may continue until the work machine 10 is slowed down or stopped. To help inhibit the uncontrolled oscillations, the steering assembly 38 includes a damping mechanism between the machine frame 14 and the pivot frame 42.

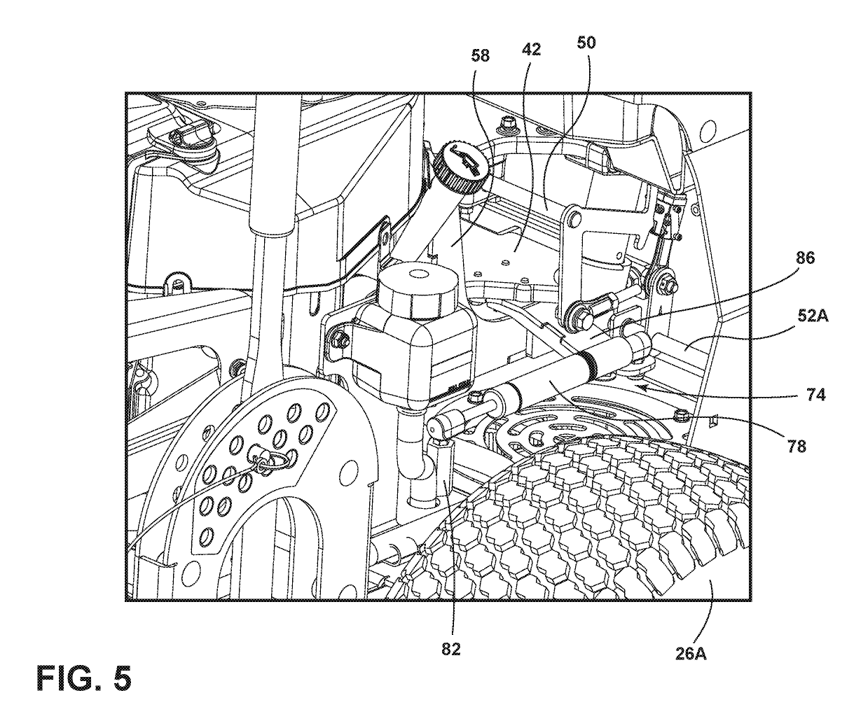

FIG. 5 illustrates one example of a damping mechanism 74. The damping mechanism 74 is offset from the pivot axis 66. The illustrated damping mechanism 74 includes a linear damper 78, such as a hydraulic damper, a gas damper, a non-hydraulic friction damper, or the like. In other embodiments, the damping mechanism 74 may include other types of viscous (e.g., hydraulic) or mechanical (e.g., friction) dampers. The linear damper 78 includes a first end coupled to a post 82 on the machine frame 14, and a second end coupled to a lever arm 86 extending laterally from the pivot frame 42. When the pivot frame 42 moves relative to the machine frame 14, the linear damper 78 is actuated (e.g., shortened or lengthened) to resist the relative motion between the pivot frame 42 and the machine frame 14. This arrangement eliminates quick changes of position between the machine frame 14 and the pivot frame 42 during turns, thereby inhibiting the work machine 10 from oscillating.

In some embodiments, the damping mechanism 74 may be adjustable. For example, the lever arm 86 may include multiple mounting locations to which the first end of the linear damper 78 may be coupled. Such an arrangement allows the damping mechanism 74 to be adjusted for different weights of cutting decks (or other work implements), or for variations of different types/strengths of dampers.

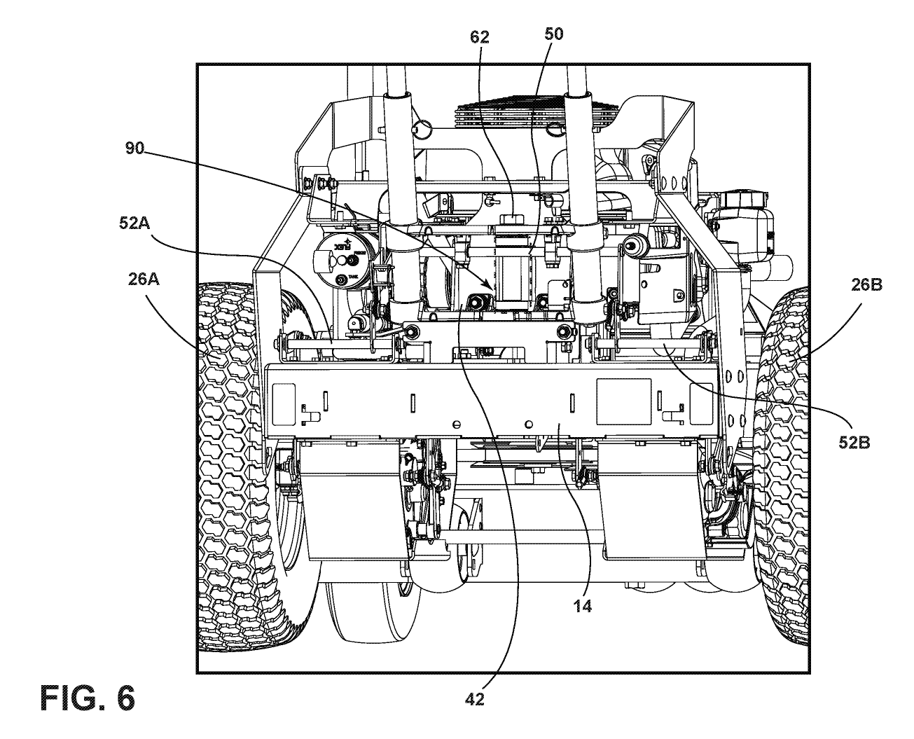

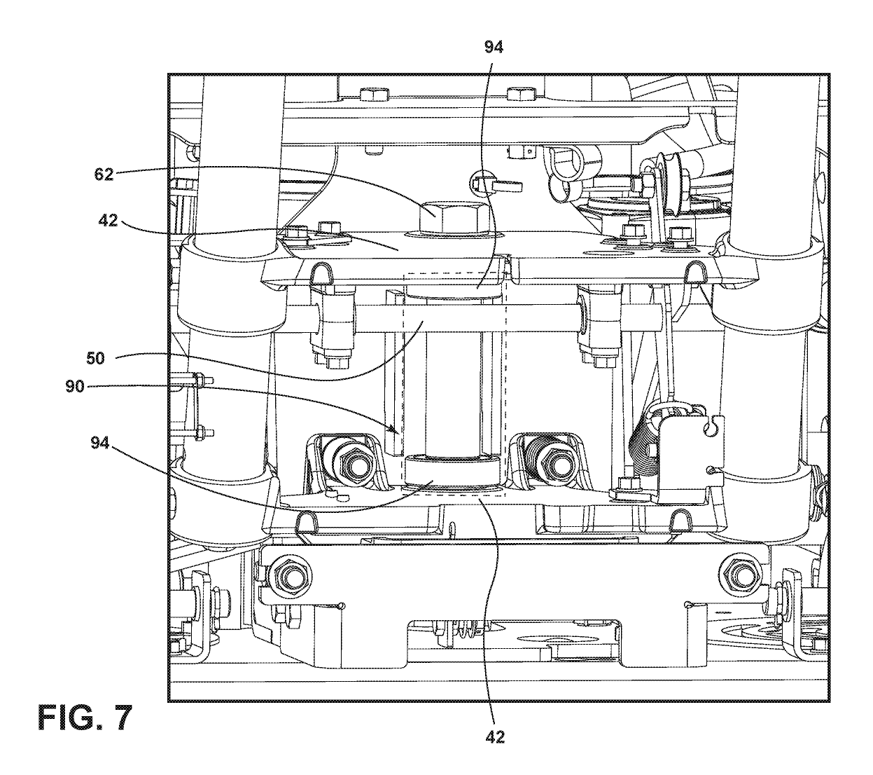

FIGS. 6 and 7 illustrate another example of a damping mechanism 90 (shown schematically in phantom lines). The damping mechanism 90 is aligned with the pivot axis 66. The illustrated damping mechanism 90 includes washers 94 surrounding the fasteners 62 that connect the pivot frame 42 to the machine frame 14. In some embodiments, the washers 94 may be spring-type washers, such as Belleville washers. In other embodiments, the washers 94 may be made of materials with relatively high coefficients of friction, such as friction bearings or other suitable device. In further embodiments, the damping mechanism 90 may include rotary viscous or mechanical dampers surrounding the fasteners 62. When the pivot frame 42 moves relative to the machine frame 14, the washers or friction bearings 94 resist motion to dampen the relative motion. This arrangement also eliminates quick changes of position between the machine frame 14 and the pivot frame 42 during turns, thereby inhibiting the work machine 10 from oscillating.

In some embodiments, the damping mechanisms 74, 90 may include internal, self-centering features that return the steering assembly 38 to a set position (e.g., neutral). In such embodiments, the spring elements 72 may be omitted.

In some embodiments, the steering assembly 38 may include both the damping mechanism 74 that is offset from the pivot axis 66 and the damping mechanism 90 that is aligned with the pivot axis 66. In other embodiments, other damping mechanisms between the machine frame 14 and the pivot frame 42 may also or alternatively be employed.

Various features and advantages of the invention are set forth in the following claims.

What is claimed is:

1. A work machine comprising:
a machine frame;
a prime mover supported by the machine frame;
wheels rotatably coupled to the machine frame and driven by the prime mover, the wheels being supported on a ground surface; and
a steering assembly including a pivot frame pivotally coupled to the machine frame about a pivot axis, the steering assembly being pivotable about the pivot axis relative to the machine frame to turn the work machine, and the steering assembly also including a damping mechanism positioned between the pivot frame and the machine frame to inhibit oscillation.

2. The work machine of claim 1, wherein the damping mechanism is offset from the pivot axis.

3. The work machine of claim 2, wherein the damping mechanism includes a linear damper.

4. The work machine of claim 1, wherein the damping mechanism is aligned with the pivot axis.

5. The work machine of claim 4, wherein the damping mechanism includes one selected from the group consisting of a washer and a rotary damper.

6. The work machine of claim 1, wherein the damping mechanism resists relative motion between the pivot frame and the machine frame.

7. The work machine of claim 1, wherein the damping mechanism includes a first end coupled to the machine frame and a second end coupled to the pivot frame, wherein the damping mechanism is adjustable by coupling the second end to different mounting locations on the pivot frame, thereby adjusting the damping magnitude of the damping mechanism.

8. The work machine of claim 1, further comprising a cutting deck selectively coupleable to the machine frame.

9. The work machine of claim 1, further comprising a handlebar that is fixed to the pivot frame, wherein the handlebar includes a twist grip that controls a rotational speed and direction of the wheels.

10. The work machine of claim 9, further comprising hydrostatic transmissions driven by the prime mover, wherein each hydrostatic transmission independently drives a corresponding wheel in response to a degree of rotation of the twist grip.

11. The work machine of claim 1, further comprising a handlebar that is fixed to the pivot frame, wherein the steering assembly pivots about the pivot axis when the handlebar is rotated to change a rotational speed of the wheels proportionally with rotation of the handlebar.

12. The work machine of claim 1, wherein the steering assembly is positioned rearward of the prime mover.

13. The work machine of claim 1, wherein the pivot axis of the steering assembly is a substantially vertical axis relative to the ground surface.

14. The work machine of claim 1, further comprising spring elements disposed on laterally opposite sides of the pivot axis of the steering assembly to bias the steering assembly to a neutral, non-steering position.

15. A work machine comprising:
a machine frame;
a prime mover supported by the machine frame;
wheels rotatably coupled to the machine frame and driven by the prime mover, the wheels being supported on a ground surface;
a steering assembly pivotally coupled to the machine frame rearward of the prime mover; and
a damping mechanism interconnecting the steering assembly and the machine frame to resist motion therebetween.

16. The work machine of claim 15, wherein the steering assembly pivots about a pivot axis that is oriented substantially perpendicular to the ground surface.

17. The work machine of claim 16, wherein the damping mechanism is offset from the pivot axis.

18. The work machine of claim 17, wherein the damping mechanism includes a linear damper.

19. The work machine of claim 16, wherein the damping mechanism is aligned with the pivot axis.

20. The work machine of claim 19, wherein the damping mechanism includes one selected from the group consisting of a washer and a rotary damper.
